(19) United States
(12) Patent Application Publication
(10) Pub. No.: US 2025/0073996 A1
(43) Pub. Date: Mar. 6, 2025

(54) INCREASING A HEIGHT OF A 3D-PRINTED PART

(71) Applicant: XEROX CORPORATION, NORWALK, CT (US)

(72) Inventors: Erwin Ruiz, Rochester, NY (US); Timothy G. Shelhart, West Henrietta, NY (US); Nadish Anand, Redwood City, CA (US); James Root, Avon, NY (US); Derek A. Bryl, Churchville, NY (US); Brian Gillis, Penfield, NY (US); Matthew R. McLaughlin, Rochester, NY (US); Peter Knausdorf, Henrietta, NY (US); Wade F. Thomas, Rochester, NY (US); Kareem Tawil, Pittsford, NY (US); Prince Joseph, Raleigh, NC (US); Fredrik Perman, Raleigh, NC (US)

(73) Assignee: XEROX CORPORATION, NORWALK, CT (US)

(21) Appl. No.: 18/239,485

(22) Filed: Aug. 29, 2023

(51) Int. Cl. B29C 64/295; B29C 64/209; B29C 64/245

(52) U.S. Cl. CPC B29C 64/295; B29C 64/209; B29C 64/245; B33Y 10/00; B33Y 30/00

(57) ABSTRACT

A 3D printer configured to print a 3D part includes an ejector having a nozzle that is configured to eject drops of a build material. The 3D printer also includes a build plate positioned below the nozzle. The drops land and solidify on the build plate to form at least a portion of the 3D part. The 3D printer also includes a first heater positioned under or within the build plate. The first heater is configured to heat the build plate and the 3D part thereon. The 3D printer also includes a second heater positioned laterally-offset from the build plate. The second heater is configured to heat a volume of air between the nozzle and an upper surface of the 3D part. The 3D printer also includes an enclosure. The nozzle, the build plate, the first heater, and the second heater are positioned at least partially within the enclosure.

### TECHNICAL FIELD

The present teachings relate generally to three-dimensional (3D) printing and, more particularly, to systems and methods for increasing a height to which a 3D part may be printed by a 3D printer.

### BACKGROUND

Three-dimensional (3D) printing jets a liquid build material through an ejector. A plurality of drops of the liquid build material are ejected from a nozzle of the ejector. The drops fall onto a build plate where they cool and solidify to form a 3D part. When the build material is a liquid metal (e.g., aluminum), as the height of the 3D part increases during printing, the temperature of the top surface of the 3D part decreases, falling out of its optimum coalescent temperature latitude. This can lead to degraded physical properties such as fatigue strength and tensile strength as well as appearance and dimensional issues with the 3D part. Any of these dysfunctions may limit the capability of the 3D printer to increase the height of the 3D part (i.e., to make the 3D part taller).

Testing has shown that, to properly fuse the molten aluminum to the base build material, the receiving (e.g., upper) surface temperature of the 3D part needs to be controlled to be approximately 380° C. to 550° C. 3D printers currently use a heated base plate set to 450° C. for 4008 Al and 550° C. for 6061 Al, for the initial build layers. However, as the 3D part continues to grow taller (e.g., away from the base plate), the conduction heat from the base plate is unable to maintain the optimum temperature on the upper surface of the 3D part that is required to ensure a good bonding between the molten drop and the upper surface of the 3D part. This results in porosity in the 3D part, uneven build surfaces, unwelded drops, and/or shape inconsistencies. As mentioned above, any of these dysfunctions will limit the capability of the 3D printer to increase the height of the 3D part (i.e., to make the 3D part taller).

Previous enclosure concepts rely upon maintaining the entire inner volume of the enclosure at the same temperature to ensure that the temperature of the upper surface of the 3D part is within its latitude while printing. In order to keep the whole inner volume at a constant temperature, the system must be sealed on all sides. This approach requires a full lower dynamic X-Y axes telescopic shield to seal the enclosure bottom. By raising the temperature in the inner volume, the temperature of the 3D part can be controlled. The controlled temperature in the inner volume allows the 3D part (and the upper surface thereof) to be heated as the 3D part is moved through the X, Y, and Z build pattern to create the upper surface layer. By maintaining the necessary elevated temperature throughout the 3D part itself, the 3D printer allows for heating the upper surface of the 3D part as it traverses under the incoming molten drops. Some of the methods that can be used to raise and control the temperature are heating methods such as infrared (IR) heating, injected heated argon gas, ceramic heaters, convective heating, etc.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A 3D printer configured to print a 3D part is disclosed. The 3D printer includes an ejector having a nozzle that is configured to eject drops of a build material. The 3D printer also includes a build plate positioned below the nozzle. The drops land and solidify on the build plate to form at least a portion of the 3D part. The 3D printer also includes a first heater positioned under or within the build plate. The first heater is configured to heat the build plate and the 3D part thereon. The 3D printer also includes a second heater positioned laterally-offset from the build plate. The second heater is configured to heat a volume of air between the nozzle and an upper surface of the 3D part. The 3D printer also includes an enclosure. The nozzle, the build plate, the first heater, and the second heater are positioned at least partially within the enclosure. The 3D printer also includes a controller configured to cause the first heater, the second heater, or both to maintain a temperature of an upper portion within the enclosure within a predetermined temperature range as a height of the 3D part increases within a predetermined height range.

In another embodiment, the 3D printer includes an ejector having a nozzle that is configured to eject drops of a build material. The build material includes a metal, and the metal includes aluminum. The 3D printer also includes a build plate positioned below the nozzle. The drops land and solidify on the build plate to form at least a portion of the 3D part. The 3D printer also includes a first heater positioned under the build plate. The first heater is configured to heat the build plate and the 3D part thereon. The 3D printer also includes a second heater positioned laterally-offset from the build plate. The second heater is configured to heat a volume of air between the nozzle and an upper surface of the 3D part. The second heater includes a pair of 2 kW lamps, a pair of 3 KW lamps, or both. The 3D printer also includes a heat shield positioned below the build plate. The build plate, the first heater, and the heat shield are configured to move in a horizontal plane. The 3D printer also includes a bellows positioned laterally-offset from the build plate and the heat shield. The bellows includes a metal insert bellows. The bellows is configured to extend and retract as the build plate, the first heater, and the heat shield move toward or away from the bellows in the horizontal plane. The 3D printer also includes an enclosure. The nozzle, the build plate, the first heater, the second heater, the heat shield, and the bellows are positioned at least partially within the enclosure. The 3D printer also includes a controller configured to cause the first heater, the second heater, or both to maintain a temperature of an upper portion within the enclosure within a predetermined temperature range as a height of the 3D part increases within a predetermined height range. The upper portion includes the upper surface of the 3D part, the volume of air between the nozzle and the upper surface of the 3D part, or both. The predetermined temperature range is from about 380° C. to about 470° C. The predetermined height range is from about 50 mm to about 300 mm.

A method for printing a 3D part using a 3D printer is also disclosed. The method includes ejecting drops of a build material from a nozzle of the 3D printer. The drops land and solidify on a build plate to form at least a portion of the 3D part. The build plate and the 3D part are positioned at least partially within an enclosure. The method also includes maintaining a temperature in an upper portion of the enclosure within a predetermined temperature range as a height of the 3D part increases within a predetermined height range. The upper portion includes the upper surface of the 3D part, a volume of air between the nozzle and the upper surface of the 3D part, or both. The predetermined temperature range is from about 380° C. to about 470° C. The predetermined height range is from about 50 mm to about 300 mm.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional side view of a 3D printer, according to an embodiment.

FIG. 2 illustrates a perspective view of a portion of the 3D printer showing an enclosure, according to an embodiment.

FIG. 3 illustrates another perspective view of a portion of the 3D printer showing the enclosure and vertical mounting rails, according to an embodiment.

FIG. 4 illustrates another perspective view of a portion of the 3D printer showing the enclosure with a front door removed, according to an embodiment.

FIGS. 5A and 5B illustrate additional perspective views of a portion of the 3D printer showing heating function components and a shield, according to an embodiment.

FIG. 6A illustrates a graph showing a temperature of an air cloud and/or the upper surface of the 3D part versus time as the 3D part is printed taller, according to an embodiment.

FIG. 6B illustrates a graph showing a temperature of the air cloud and/or the upper surface of the 3D part versus time as the 3D part is printed taller, according to an embodiment.

FIG. 7A illustrates a graph showing a temperature of the air cloud and/or the upper surface of the 3D part versus time as the 3D part is printed taller, according to an embodiment.

FIG. 7B illustrates a graph showing a temperature of the air cloud and/or the upper surface of the 3D part versus time as the 3D part is printed taller, according to an embodiment.

FIG. 8 illustrates a flowchart of a method for printing a 3D part using the 3D printer, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides a 3D printer and method for heating and maintaining the temperature of an upper surface of a 3D part without heating and maintaining the temperature of the entire inner volume of an enclosure in which the 3D part is located. This may improve bonding between each layer of the 3D part, particularly as the height of the part increases past a predetermined height threshold. To ensure a good coalescence between the jetted drops, during printing, the upper surface of the 3D part may be maintained within a predetermined temperature range as the height of the 3D part (e.g., the distance between the upper surface of the 3D part and the build plate) exceeds the predetermined threshold (e.g., 50 mm, 100 mm, 150 mm, 200 mm, or 250 mm). The predetermined temperature range may be between about 440° C. and about 470° C. (e.g., for Al 6061) or between about 380° C. to about 420° C. (e.g., for Al 4008).

The upper surface of the 3D part may be heated by controlling the air temperature between the print head (e.g., nozzle) and the upper surface of the 3D part. In other words, a surrogate to control the temperature of the upper surface of the 3D part is to instead control the temperature of the volume of air in the enclosure between the print head and the upper surface of the 3D part. This volume of air may be referred to as the cloud temperature.

A thermocouple may be placed between the print head and the upper surface of the 3D part to measure and control the cloud temperature. The cloud temperature may be achieved by introducing heat with one or more infrared (IR) lamps. Each lamp may include a set (or pair) of 2 kW and/or 3 KW lamps, which may be fired in a sequence while printing, depending on the height of the 3D part. As used herein, a set/pair of 2 kW lamps refers to stage 1 that is configured to generate 4 kW of combined heat, and a set/pair of 3 kW lamps refers to stage 2 that is configured to generate 6 kW of combined heat. A PID closed-loop control system may be used to monitor and maintain the cloud temperature and/or power of the lamps.

The enclosure may adjust in size by moving a top plate surface (e.g., plunger) as the 3D part is printed. In this way, the temperature of the upper surface of the 3D part may be controlled to improve the surface bonding as the drops come into contact with the upper surface of the 3D part. This may be achieved without the need of a conventional fully (e.g., 100%) X-Y bottom shield.

By controlling the cloud temperature of the volume of air and not the total inner volume of the enclosure, the temperature of the upper surface of the 3D part can be controlled, thereby allowing the two surfaces (e.g., the drop and the 3D part) to be optimized for a more complete and controlled bonding, leading to better build quality and improved material properties across the bond and throughout the finished part. It may also reduce the porosity of the 3D part, increase the yield strength of the 3D part, increase the fatigue cycles, increase the surface quality of the 3D part, or a combination thereof.

Maintaining the cloud temperature during printing may allow the 3D printer to print taller 3D parts. In an example, the 3D parts may be printed up to a height of 200 mm, 250 mm, 300 mm, or more when the build material is a 4008 aluminum alloy or 6061 aluminum alloy. The 3D printer may also re-use heat provided by the IR lamps(s) (e.g., to heat the shield), which improves the efficiency of the 3D printer. The 3D printer may also include an X-axis shield that blocks and protects components of the 3D printer from the heat/radiation from the lamp(s). The 3D printer may include a dynamically-expandable partial enclosure that allows for controlled heating of the upper surface of the 3D part. The 3D printer may also include a one-axis hybrid shield configured to protect components of the 3D printer from IR radiation. In an example, the volume inside the enclosure may be 300 mm×300 mm×300 mm.

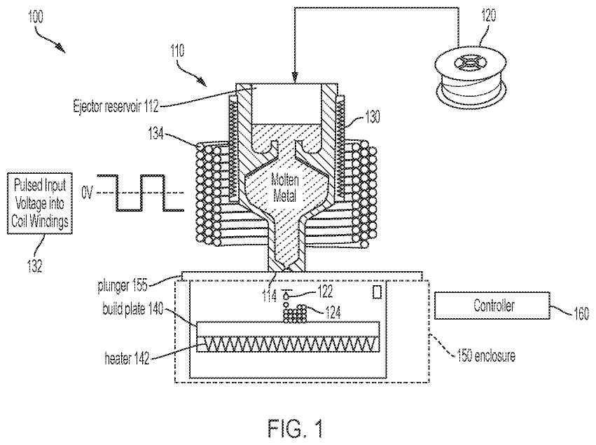

FIG. 1 depicts a schematic cross-sectional side view of a 3D printer 100, according to an embodiment. The 3D printer 100 may be or include a magnetohydrodynamic (MHD) printer, a piezoelectric-driven printer, or the like. The 3D printer 100 may include an ejector (also referred to as a pump) 110. As used herein, the ejector 110 refers to a structure that can be selectively activated to cause a build material 120 to be ejected from a nozzle 114 of the ejector 110. As used herein, the nozzle 114 refers to a physical structure from which the build material 120 begins flight.

The ejector 110 may define one or more reservoirs 112. One ejector reservoir 112 is shown in FIG. 1. In another embodiment, the ejector 110 may include two or more reservoirs including at least a first (e.g., upper) reservoir and a second (e.g., lower) reservoir. In this embodiment, the portion of the ejector 110 defining the upper reservoir may be or include a ceramic material, and the portion of the ejector 110 defining the lower reservoir may be or include a graphite material.

The ejector reservoir(s) 112 is/are configured to receive and/or store the build material 120 that is to be ejected from the nozzle 114. The build material 120 may be or include a metal (e.g., pure or an alloy), a polymer, a ceramic, ink, or the like. In one embodiment, the build material 120 may be greater than about 50% metal, greater than 60% metal, greater than 70% metal, greater than 80% metal, greater than 90% metal, or about 100% metal (e.g., by volume and/or mass). For example, the build material 120 may be or include a spool of aluminum wire (e.g., 6061 aluminum). In another embodiment, the build material 120 may be or include copper or other metals.

The 3D printer 100 may also include one or more heating elements 130. The heating elements 130 are configured to melt the build material 120 within the ejector reservoir 112, thereby converting the build material 120 from a solid state to a liquid (e.g., molten) state within the ejector reservoir 112.

The 3D printer 100 may also include a power source 132 and one or more metallic coils 134. The metallic coils 134 are wrapped at least partially around the ejector 110 and/or the heating elements 130. The power source 132 may be coupled to the coils 134 and configured to provide power thereto. In one embodiment, the power source 132 may be configured to provide a step function direct current (DC) voltage profile (e.g., voltage pulses or jetting pulses) to the coils 134, which may create an increasing magnetic field. The increasing magnetic field may cause an electromagnetic and/or electromotive force within the ejector 110, that in turn causes an induced electrical current in the liquid build material 120. The magnetic field and the induced electrical current in the liquid build material 120 may create a radially inward force on the liquid build material 120, known as a Lorentz force. The Lorentz force creates a pressure at an inlet of the nozzle 114 of the ejector 110. The pressure causes the liquid build material 120 to be jetted through and/or ejected from the nozzle 114 in the form of one or more drops 122.

The 3D printer 100 may also include a build plate (also referred to as a substrate) 140 that is positioned below the nozzle 114. The drops 122 may be ejected from the nozzle 114 and subsequently land on the build plate 140 where they may cool and solidify to form a first (e.g., bottom) layer. Additional drops 122 may be jetted to form layer upon layer that eventually produces a 3D part 124. The build plate 140 may include a build plate heater (also referred to as a bed heater) 142 that is configured to heat the build plate 140 and the drops 122 and/or 3D part 124 thereon. The build plate heater 142 may be positioned within or below the build plate 140.

The 3D printer 100 may also include an enclosure 150. The ejector 110 (e.g., the nozzle 114), the heating elements 130, the coils 134, the build plate 140, or a combination thereof may be positioned at least partially within the enclosure 150. The 3D printer 100 may also include a plunger 155 positioned proximate to a top of the enclosure 150. The plunger 155 may be configured to move vertically within the enclosure 150 to vary the volume within the enclosure 150. The plunger 155 may also provide a thermal shield that protects the ejector 110, water cooling lines, and other components from the heat within the enclosure 150.

The 3D printer 100 may also include controller 160. The controller 160 may control the cloud temperature and/or the temperature of the upper surface of the 3D part 124 as the 3D part grows taller during printing.

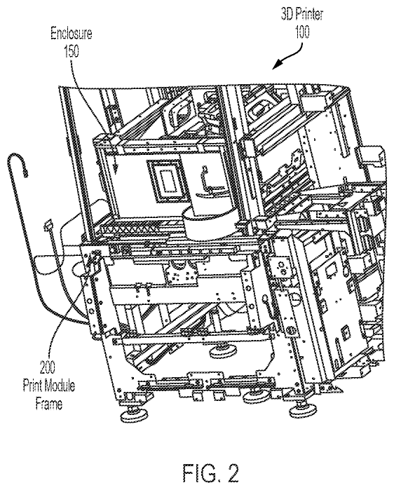

FIG. 2 illustrates a perspective view of a portion of the 3D printer 100 showing the enclosure 150, according to an embodiment. The enclosure 150 may contain and maintain the cloud temperature of the volume of air. The enclosure 150 may also or instead protect the components (e.g., a Z height laser scanner, water cooling lines, drive systems, and other electronic components) that are adjacent to the printing area.

The 3D printer 100 may also include a print module frame 200. The print module frame 200 may be or include a rigid structure that support the granite machine datum base, as well as the drive system and other functional components.

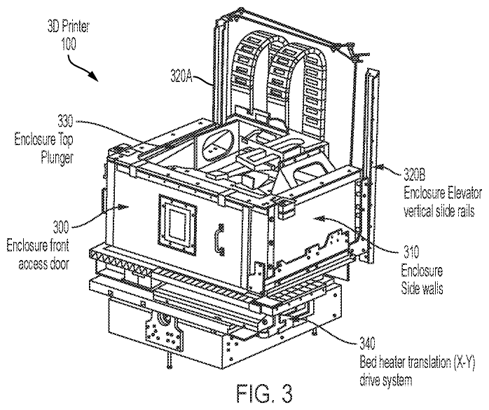

FIG. 3 illustrates another perspective view of a portion of the 3D printer 100 showing the enclosure 150, according to an embodiment. The enclosure 150 may include a (e.g., front) access door 300 and one or more side walls (one is shown: 310). The access door 300 may be configured to actuate between an open position and a closed position. The open position allows access to the internal volume of the enclosure 150.

The 3D printer 100 may also include one or more rails (two are shown: 320A, 320B). The rails 320A, 320B may be or include elevator vertical slide rails. The enclosure 150 may be configured to move from a first (e.g., lower) position to a second (e.g., upper) position along the rails 320A, 320B. The enclosure 150 may be in the lower position during printing. The enclosure 150 may be in the upper position to remove the 3D part 124 after printing. The enclosure 150 may also be in the upper position during service/repair of the 3D printer 100.

The 3D printer 100 may also include a build plate heater translation drive system 340. The drive system 340 may be configured to move the build plate 140 and/or the heater 142 in a horizontal (e.g., X-Y) plane during printing.

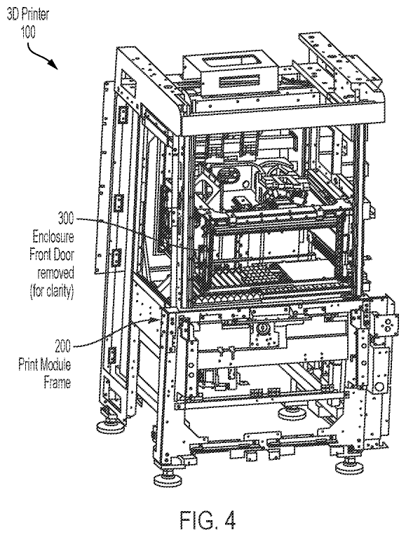

FIG. 4 illustrates another perspective view of a portion of the 3D printer 100 showing the enclosure 150 with the front access door 300 removed for clarity, according to an embodiment. When the door 300 is open (or removed), a user can measure a size (e.g., mass) of the drops 122 that are jetted through the nozzle 114. The user may also inspect the printer operations.

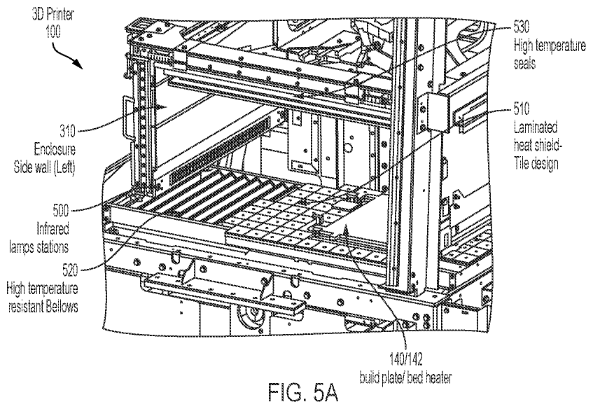

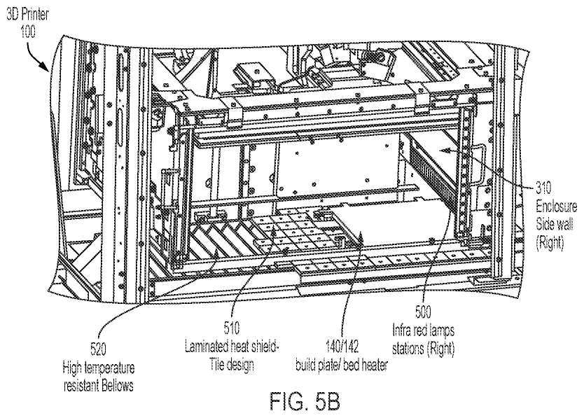

FIGS. 5A and 5B illustrate additional perspective view of a portion of the 3D printer 100 showing heating function components and a shield 510, according to an embodiment. The heating function components may be or include the build plate heater 142. The heating function components may also or instead be or include one or more (e.g., infrared) lamps 500. The lamps 500 may be positioned above the build plate 140 and/or heater 142. The lamps 500 may heat the drops 122 and/or the 3D part 124. The lamps 500 may include one or more (e.g., a pair) of 2 kW lamps. In another embodiment, the lamps 500 may include one or more (e.g., a pair) of 3 kW lamps.

The 3D printer 100 may also include a heat shield 510 that is configured to contain the heat within the inner volume of the enclosure 150. The heat shield 510 may be positioned below the build plate 140 and/or the heater 142.

The 3D printer 100 may also include a bellows 520 that is configured to contain the heat within the inner volume of the enclosure 150. The bellows 520 may be positioned below the build plate 140, heater 142, the heat shield 510 or a combination thereof. The bellows 520 may also or instead be positioned laterally-offset from the build plate 140, heater 142, the heat shield 510 or a combination thereof. The bellows 520 may be configured to expand and contract as the bed heater 142 and/or heat shield 510 moves in the horizontal plane to prevent heat from escaping out of the bottom of the enclosure 150. The heat shield 510 and/or bellows 520 may cover (e.g., prevent heat from escaping through) from about 30% to about 70%, about 40% to about 80%, about 50% to about 90%, or about 60% to about 100% of a lower (e.g., horizontal) surface area of the enclosure 150.

The 3D printer 100 may also include one or more seals 530 that are configured to contain the heat within the inner volume of the enclosure 150. The seals 530 may be positioned between the side walls of the enclosure 150 and the perimeter of the plunger 155. The seals 530 may be made of a high-temperature resistant material such as Verniculite-coated fiberglass-Newtex Zetex Plus A-600.

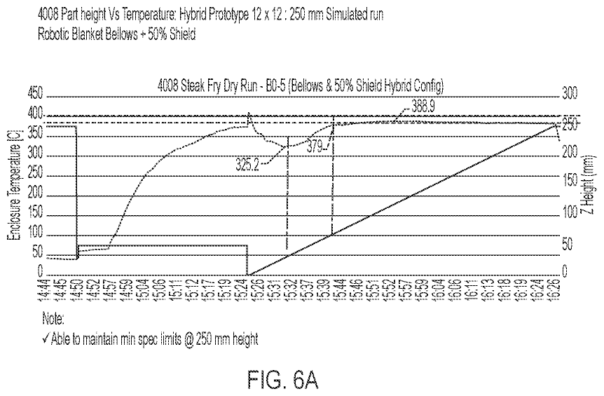

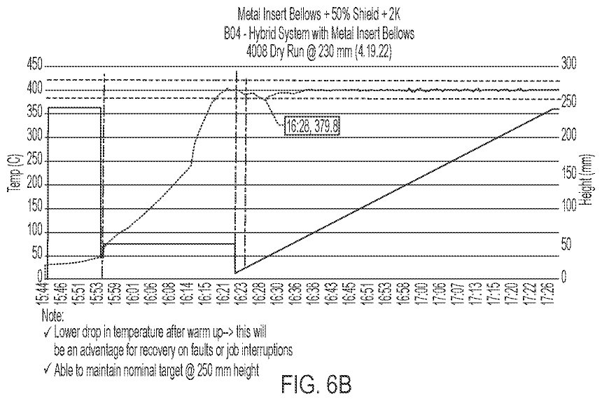

FIG. 6A illustrates a graph showing the cloud temperature (and/or the temperature of the upper surface of the 3D part 124) versus time as the 3D part 124 is printed taller, according to an embodiment. The 3D printer 100 used to generate the graph in FIG. 6A includes a 50% heat shield 510 and a robotic blanket bellows 520. Thus, the heat shield 510 covers 50% of the lower surface of the enclosure 150. In an example, a robotic blanket bellows 520 refers to an aluminized blanket TG-50 prototype.

As may be seen, the 3D printer 100 may be warming up until the 15:24 time. Then, as the printing begins and the height of the 3D part 124 begins to increase, the cloud temperature and/or the temperature of the upper surface of the 3D part 124 dips outside (e.g., below) the predetermined (e.g., desired) range for about 17 seconds. The temperature then levels off within the predetermined (e.g., desired) range as the height increases from about 75 mm to about 250 mm. In this example, the predetermined (e.g., desired) range is from about 380° C. to about 420° C.

FIG. 6B illustrates a graph showing the cloud temperature (and/or the temperature of the upper surface of the 3D part 124) versus time as the 3D part 124 is printed taller, according to an embodiment. The 3D printer 100 used to generate the graph in FIG. 6B includes 2 kW lamps 500, a 50% heat shield 510, and a metal insert bellows 520. In an example, a metal insert bellows 520 refers to Vermiculite-coated fiberglass with metal inserts to increase the thermal mass and structural stability, which takes advantage of the IR light to increase the heat.

As may be seen, the 3D printer 100 may be warming up until the 16:22 time. Then, as the printing begins and the height of the 3D part 124 begins to increase, the cloud temperature and/or the temperature of the upper surface of the 3D part 124 dips outside (e.g., below) the predetermined (e.g., desired) range for about 1 second. The temperature then levels off within the predetermined (e.g., desired) range as the height increases from about 25 mm to about 235 mm. In this example, the predetermined (e.g., desired) range is from about 380° C. to about 400° C.

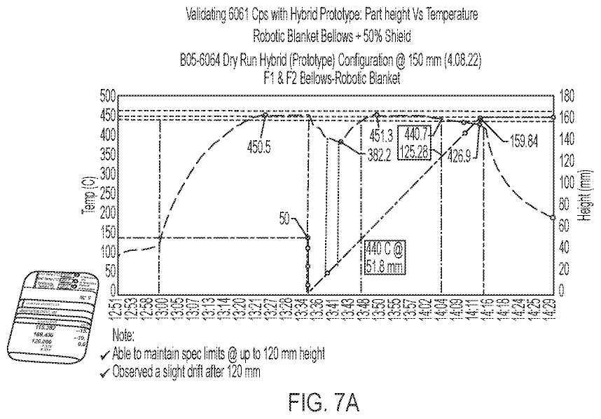

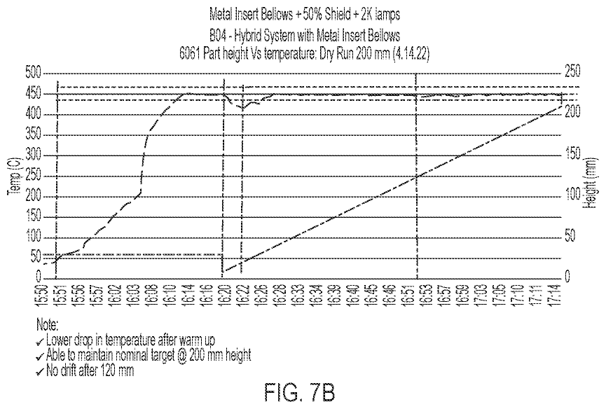

FIG. 7A illustrates a graph showing the cloud temperature (and/or the temperature of the upper surface of the 3D part 124) versus time as the 3D part 124 is printed taller, according to an embodiment. The 3D printer 100 used to generate the graph in FIG. 7A includes a 50% heat shield 510 and a robotic blanket bellows 520.

As may be seen, the 3D printer 100 may be warming up until the 13:05 time. Then, as the printing begins and the height of the 3D part 124 begins to increase, the cloud temperature and/or the temperature of the upper surface of the 3D part 124 dips outside (e.g., below) the predetermined (e.g., desired) range for about 12 seconds. The temperature then levels off within the predetermined (e.g., desired) range as the height increases from about 40 mm to about 160 mm. In this example, the predetermined (e.g., desired) range is from about 440° C. to about 470° C.

FIG. 7B illustrates a graph showing the cloud temperature (and/or the temperature of the upper surface of the 3D part 124) versus time as the 3D part 124 is printed taller, according to an embodiment. The 3D printer 100 used to generate the graph in FIG. 7B includes a pair of 2 k lamps 500, a 50% heat shield 510, and a metallic insert bellows 520.

As may be seen, the 3D printer 100 may be warming up until the 16:19 time. Then, as the printing begins and the height of the 3D part 124 begins to increase, the cloud temperature and/or the temperature of the upper surface of the 3D part 124 dips outside (e.g., below) the predetermined (e.g., desired) range for about 5 seconds. The temperature then levels off within the predetermined (e.g., desired) range as the height increases from about 30 mm to about 220 mm. In this example, the predetermined (e.g., desired) range is from about 440° C. to about 470° C.

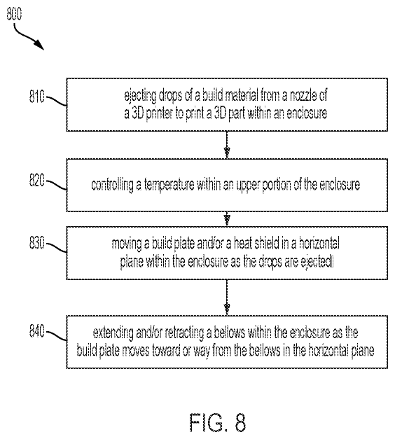

FIG. 8 illustrates a flowchart of a method 800 for printing a 3D part 124 using the 3D printer 100, according to an embodiment. An illustrative order of the method 800 is provided below; however, one or more steps of the method 800 may be performed in a different order, simultaneously, repeated, or omitted.

The method 800 may include ejecting drops of the build material 120 from the nozzle 114 of the 3D printer 100, as at 810. The drops land and solidify on the build plate 140 to form at least a portion of the 3D part 124. The 3D part 124 and the build plate 140 are positioned at least partially within the enclosure 150.

The method 800 may also include controlling the temperature within an upper portion of the enclosure, as at 820. The upper portion may include the upper surface of the 3D part 124, a volume of air between the nozzle 114 and the upper surface of the 3D part 124, or both. The temperature may be maintained within a predetermined temperature range as a height of the 3D part 124 increases within a predetermined height range. The predetermined temperature range may be from about 350° C. to about 500° C., about 380° C. to about 470° C., or about 400° C. to about 450° C. The predetermined height range may be from about 50 mm to about 100 mm, about 100 mm to about 200 mm, or about 200 mm to about 300 mm. The temperature in a lower portion within the enclosure 150 may be less than the predetermined temperature range as the height of the 3D part 124 increases within the predetermined height range.

The temperature may be maintained using the heater 500 that is positioned laterally-offset from the build plate 140. The heater 500 may be configured to heat the volume of air between the nozzle 114 and the upper surface of the 3D part 124. As mentioned above, the heater 500 may include a set of 2 KW lamps, 3 KW lamps, or both that are configured to be fired sequentially.

The method 800 may also include moving the build plate 140 and/or the heat shield 510 in a horizontal plane within the enclosure 150 as the drops 122 are ejected, as at 830. The heat shield 510 may be positioned below the build plate 140 and within the enclosure 150.

The method 800 may also include extending and/or retracting the bellows 520 within the enclosure 150 as the build plate 140 moves toward or way from the bellows 520 in the horizontal plane, as at 840. The bellows 520 may be positioned laterally-offset from the build plate 140.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A 3D printer configured to print a 3D part, the 3D printer comprising:
an ejector comprising a nozzle that is configured to eject drops of a build material;
a build plate positioned below the nozzle, wherein the drops land and solidify on the build plate to form at least a portion of the 3D part;
a first heater positioned under or within the build plate, wherein the first heater is configured to heat the build plate and the 3D part thereon;
a second heater positioned laterally-offset from the build plate, wherein the second heater is configured to heat a volume of air between the nozzle and an upper surface of the 3D part;
an enclosure, wherein the nozzle, the build plate, the first heater, and the second heater are positioned at least partially within the enclosure; and
a controller configured to cause the first heater, the second heater, or both to maintain a temperature of an upper portion within the enclosure within a predetermined temperature range as a height of the 3D part increases within a predetermined height range.

2. The 3D printer of claim 1, wherein the second heater is also positioned vertically-between the nozzle and the upper surface of the 3D part, and wherein the second heater comprises one or more 2 kW lamps, one or more 3 kW lamps, or both.

3. The 3D printer of claim 1, further comprising a heat shield positioned below the build plate.

4. The 3D printer of claim 3, wherein the build plate, the first heater, and the heat shield are configured to move in a horizontal plane.

5. The 3D printer of claim 3, further comprising a bellows positioned laterally-offset from the build plate and the heat shield.

6. The 3D printer of claim 5, wherein the bellows is configured to extend and retract as the build plate, the first heater, the heat shield, or a combination thereof move toward or away from the bellows in a horizontal plane.

7. The 3D printer of claim 1, wherein the upper portion comprises the upper surface of the 3D part, the volume of air between the nozzle and the upper surface of the 3D part, or both.

8. The 3D printer of claim 1, wherein the predetermined temperature range is from about 380° C. to about 470° C.

9. The 3D printer of claim 1, wherein the predetermined height range is greater than about 50 mm.

10. The 3D printer of claim 1, wherein the temperature in a lower portion within the enclosure is less than the predetermined temperature range as the height of the 3D part increases within the predetermined height range.

11. A 3D printer configured to print a 3D part, the 3D printer comprising:
an ejector comprising a nozzle that is configured to eject drops of a build material, wherein the build material comprises a metal, and wherein the metal comprises aluminum;
a build plate positioned below the nozzle, wherein the drops land and solidify on the build plate to form at least a portion of the 3D part;
a first heater positioned under the build plate, wherein the first heater is configured to heat the build plate and the 3D part thereon;
a second heater positioned laterally-offset from the build plate and vertically-between the nozzle and the 3D part, wherein the second heater is configured to heat a volume of air between the nozzle and an upper surface of the 3D part, and wherein the second heater comprises a pair of 2 kW lamps, a pair of 3 kW lamps, or both;
a heat shield positioned below the build plate, wherein the build plate, the first heater, and the heat shield are configured to move in a horizontal plane;
a bellows positioned laterally-offset from the build plate and the heat shield, wherein the bellows comprises a metal insert bellows, and wherein the bellows is configured to extend and retract as the build plate, the first heater, and the heat shield move toward or away from the bellows in the horizontal plane;
an enclosure, wherein the nozzle, the build plate, the first heater, the second heater, the heat shield, and the bellows are positioned at least partially within the enclosure; and
a controller configured to cause the first heater, the second heater, or both to maintain a temperature of an upper portion within the enclosure within a predetermined temperature range as a height of the 3D part increases within a predetermined height range, wherein the upper portion comprises the upper surface of the 3D part, the volume of air between the nozzle and the upper surface of the 3D part, or both, wherein the predetermined temperature range is from about 380° C. to about 470° C., wherein the predetermined height range is from about 50 mm to about 300 mm.

12. The 3D printer of claim 11, further comprising:
a plunger positioned at least partially within the enclosure, wherein the plunger is configured to move vertically within the enclosure; and
one or more seals positioned between the enclosure and the plunger, wherein the one or more seals are configured to contain heat within the enclosure.

13. The 3D printer of claim 11, wherein the pair of 2 kW lamps, the pair of 3 kW lamps, or both are configured to fire in sequence.

14. The 3D printer of claim 11, wherein the heat shield covers from about 30% to about 70% of a lower horizontal area of the enclosure.

15. The 3D printer of claim 11, wherein the temperature in a lower portion within the enclosure is less than the predetermined temperature range as the height of the 3D part increases within the predetermined height range.

16. A method for printing a 3D part using a 3D printer, the method comprising:
ejecting drops of a build material from a nozzle of the 3D printer, wherein the drops land and solidify on a build plate to form at least a portion of the 3D part, and wherein the build plate and the 3D part are positioned at least partially within an enclosure; and
maintaining a temperature in an upper portion of the enclosure within a predetermined temperature range as a height of the 3D part increases within a predetermined height range, wherein the upper portion comprises the upper surface of the 3D part, a volume of air between the nozzle and the upper surface of the 3D part, or both, wherein the predetermined temperature range is from about 380° C. to about 470° C., and wherein the predetermined height range is from about 50 mm to about 300 mm.

17. The method of claim 16, wherein the temperature is maintained using a heater that is positioned laterally-offset from the build plate, wherein the heater is configured to heat the volume of air between the nozzle and an upper surface of the 3D part, and wherein the heater comprises a pair of 2 kW lamps, a pair of 3 kW lamps, or both that are configured to be fired sequentially.

18. The method of claim 16, further comprising moving the build plate and a heat shield in a horizontal plane as the drops are ejected, wherein the heat shield is positioned below the build plate, and wherein the heat shield comprises laminated tiles.

19. The method of claim 16, further comprising extending or retracting a bellows as the build plate moves toward or way from the bellows in a horizontal plane, wherein the bellows is positioned laterally-offset from the build plate.

20. The method of claim 16, wherein the temperature in a lower portion within the enclosure is less than the predetermined temperature range as the height of the 3D part increases within the predetermined height range.
